(19) United States
(12) Patent Application Publication
(10) Pub. No.: US 2025/0056491 A1
(43) Pub. Date: Feb. 13, 2025

(54) METHOD AND DEVICE FOR DETERMINING LOCATION INFORMATION

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/720,380

(22) PCT Filed: Dec. 17, 2021
(86) PCT No.: PCT/CN2021/139336

§ 371 Date: Jun. 14, 2024

(51) Int. Cl. H04W 64/00; H04L 5/00; H04W 24/10

(52) U.S. Cl. CPC H04W 64/003; H04L 5/0055; H04W 24/10

(57) ABSTRACT

Disclosed in the embodiments of the present disclosure are methods and devices for determining location information. One of the methods performed by a network device includes triggering, in response to determining that location information reported by a first terminal meets a preset condition, the first terminal to perform Timing Advance (TA) reporting.

### CROSS-REFERENCE TO RELATED APPLICATIONS

The present disclosure is the U.S. National phase application of International Application No. PCT/CN2021/139336, filed on Dec. 17, 2021, the entire content of which is incorporated herein by reference for all purposes.

### TECHNICAL FILED

The present disclosure relates to the field of communication technology, and in particular, to a method and device for determining location information.

### BACKGROUND

With the continuous development of Internet of Things (IoT) applications, the stringent in complex everything-is-connected scenarios.

In the related art, in satellite communication networks, the terminal needs to perform positioning through the Global Navigation Satellite System (GNSS) to determine its own location information and report it to the network device, so that the network device can perform resource scheduling based on the reported location information. When the location information reported by the terminal is inaccurate, the time-frequency resources allocated by the network device for the terminal may conflict with those of other terminals, thereby affecting the normal communication of other terminals.

### SUMMARY

Embodiments of the present disclosure provide a method and device for determining location information.

In a first aspect, according to the embodiments of the present disclosure, there is provided a method for determining location information. The method is performed by a network device and includes triggering, in response to determining that location information reported by a first terminal meets a preset condition, the first terminal to perform timing advance (TA) reporting.

In a second aspect, according to the embodiments of the present disclosure, there is provided another method for determining location information. The method is performed by a terminal. The method includes initiating an execution of TA reporting based on triggering of a network device or self-triggering of the terminal.

In a third aspect, according to the embodiments of the present disclosure, there is provided a communication device that includes a processor. When the processor executes a computer program stored in a memory, the processor performs the method described in the first aspect.

In a fourth aspect, according to the embodiments of the present disclosure, there is provided a communication device that includes a processor. When the processor executes a computer program stored in a memory, the processor performs the method described in the second aspect.

In a fifth aspect, according to the embodiments of the present disclosure, there is provided a communication device that includes a processor and a memory, wherein the memory stores a computer program. The processor executes the computer program stored in the memory to enable the communication device to execute the method described in the first aspect.

In a sixth aspect, according to the embodiments of the present disclosure, there is provided a communication device that includes a processor and a memory, wherein the memory stores a computer program. The processor executes the computer program stored in the memory to enable the communication device to execute the method described in the second aspect.

In a seventh aspect, according to the embodiments of the present disclosure, there is provided a communication device that includes a processor and an interface circuit. The interface circuit is configured to receive code instructions and transmit them to the processor. The processor is configured to run the code instructions to enable the communication device to execute the method described in the first aspect.

In an eighth aspect, according to the embodiments of the present disclosure, there is provided a communication device that includes a processor and an interface circuit. The interface circuit is configured to receive code instructions and transmit them to the processor. The processor is configured to run the code instructions to enable the communication device to execute the method described in the second aspect.

In a ninth aspect, according to the embodiments of the present disclosure, there is provided a system for determining location information that includes the communication device described in the third aspect and the communication device described in the fourth aspect, or includes the communication device described in the fifth aspect and the communication device described in the sixth aspect, or includes the communication device described in the seventh aspect and the communication device described in the eighth aspect, or includes the communication device described in the ninth aspect and the communication device described in the tenth aspect.

In a tenth aspect, according to the embodiments of the present disclosure, there is provided a non-transitory computer-readable storage medium for storing instructions for the aforementioned terminal. When the instructions are executed, the terminal is caused to execute the method described in the first aspect.

In an eleventh aspect, according to the embodiments of the present disclosure, there is provided a non-transitory computer-readable storage medium for storing instructions for the aforementioned network device. When the instructions are executed, the network device is caused to execute the method described in the second aspect.

In a twelfth aspect, the present disclosure also provides a computer program product that includes a computer program which, when runs on a computer, causes the computer to execute the method described in the first aspect.

In a thirteen aspect, the present disclosure also provides a computer program product that includes a computer program which, when runs on a computer, causes the computer to execute the method described in the second aspect.

In a fourteenth aspect, the present disclosure provides a chip system that includes at least one processor and an interface for supporting the terminal to implement the functions involved in the first aspect, such as determining or processing at least one of the data and information involved in the aforementioned methods. In an example design, the chip system also includes a memory for storing necessary computer programs and data for the terminal. The chip system can be composed of chips or can include chips and other discrete components.

In a fifteenth aspect, the present disclosure provides a chip system that includes at least one processor and an interface for supporting the network device to implement the functions involved in the second aspect, such as determining or processing at least one of the data and information involved in the aforementioned methods. In an example design, the chip system also includes a memory for storing necessary computer programs and data for the network device. The chip system can be composed of chips or can include chips and other discrete components.

In a sixteenth aspect, the present disclosure provides a computer program which, when runs on a computer, enables the computer to execute the method described in the first aspect.

In a seventeenth aspect, the present disclosure provides a computer program which, when runs on a computer, enables the computer to execute the method described in the second aspect.

### BRIEF DESCRIPTION OF THE DRAWINGS

In order to more clearly illustrate the technical solutions in the embodiments of the present disclosure or in the “BACKGROUND” section, the drawings required for the description of the embodiments of the present disclosure and the “BACKGROUND” section will be described below.

FIG. 1 is a schematic diagram of the architecture of a communication system provided in an embodiment of the present disclosure.

FIG. 2 is a flowchart of a method for determining location information provided in an embodiment of the present disclosure.

FIG. 3 is a flowchart of another method for determining location information provided in an embodiment of the present disclosure.

FIG. 4 is a flowchart of yet another method for determining location information provided in an embodiment of the present disclosure.

FIG. 5 is a flowchart of yet another method for determining location information provided in an embodiment of the present disclosure.

FIG. 6 is a flowchart of yet another method for determining location information provided in an embodiment of the present disclosure.

FIG. 7 is a flowchart of yet another method for determining location information provided in an embodiment of the present disclosure.

FIG. 8 is a flowchart of yet another method for determining location information provided in an embodiment of the present disclosure.

FIG. 9 is a flowchart of yet another method for determining location information provided in an embodiment of the present disclosure.

FIG. 10 is a flowchart of yet another method for determining location information provided in an embodiment of the present disclosure.

FIG. 11 is a structural diagram of a communication device provided in an embodiment of the present disclosure.

FIG. 12 is a structural diagram of another communication device provided in an embodiment of the present disclosure.

FIG. 13 is a structural diagram of a chip provided in an embodiment of the present disclosure.

### DETAILED DESCRIPTION

Exemplary embodiments will be described in detail here, examples of which are shown in the accompanying drawings. In the following description, unless otherwise indicated, the same numbers in different drawings represent the same or similar elements. The implementations described in the following exemplary embodiments do not represent all of the embodiments consistent with the present disclosure. Instead, they are merely examples of devices and methods consistent with some aspects of the present disclosure as detailed in the appended claims.

For ease of understanding, the terms involved in the present disclosure are first introduced as follows.

### 1. Global Navigation Satellite System (GNSS)

The Global Navigation Satellite System (GNSS) refers to all satellite navigation systems, including global, regional, and augmented systems, such as the United States' GPS, Russia's Glonass, Europe's Galileo, China's BeiDou Navigation Satellite System, and related augmentation systems such as the United States' WAAS (i.e., Wide Area Augmentation System), Europe's EGNOS (i.e., European Geostationary Navigation Overlay System), and Japan's MSAS (i.e., Multi-Functional Satellite Augmentation System), as well as other satellite navigation systems under construction and to be built in the future.

### 2. Timing Advance (TA)

Signals have delays during spatial transmission. For example, when the terminal moves away from the base station during a call, the signal sent from the base station will arrive at the terminal “later and later,” and simultaneously, the signal from the terminal will also arrive at the base station “later and later.” Excessive delay may cause a signal received by the base station from a terminal in the current time slot to overlap with the time slot for the next terminal's signal received by the base station, causing inter-symbol interference. Therefore, during data transmission, the terminal device's uplink transmission needs to be provided with a certain advance to ensure that the time interval between the uplink transmissions of different users arriving at the base station is less than a predefined threshold. The base station can send a timing advance command to the terminal on the downlink channel to indicate the time for the terminal to perform transmission in advance, and this time is called the timing advance (TA).

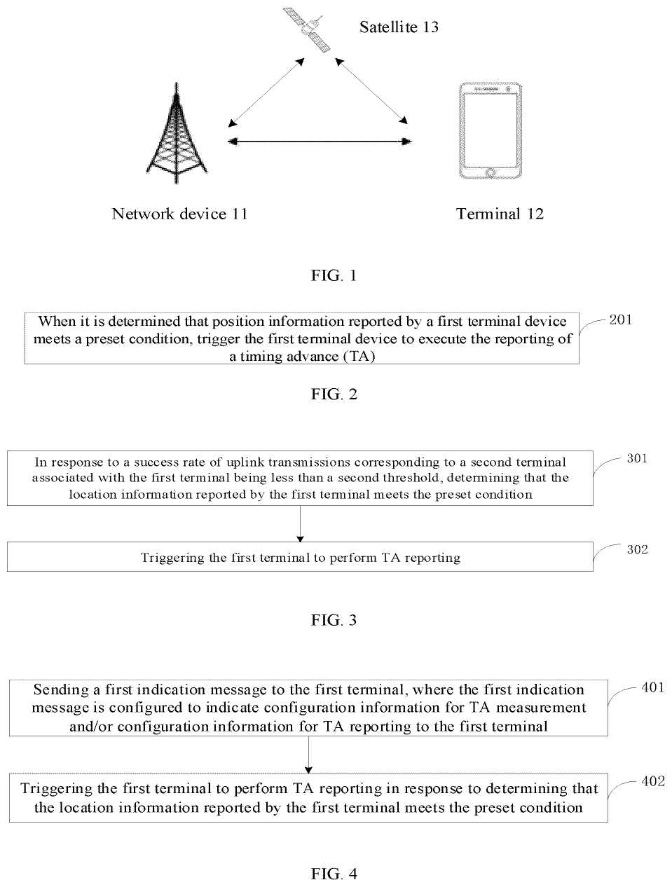

Please refer to FIG. 1, which is a schematic diagram of the architecture of a communication system provided in an embodiment of the present disclosure. The communication system can include, but is not limited to, one network device and one terminal. The number and form of devices shown in FIG. 1 are for illustrative purposes only and do not limit the embodiments of the present disclosure. In practical applications, the system may include two or more network devices and two or more terminal devices. The communication system shown in FIG. 1 includes, for example, a network device 11, a terminal 12, and a satellite 13.

It should be noted that the technical solutions of the present disclosure can be applied to various communication systems. For example, Long Term Evolution (LTE) systems, 5th Generation (5G) mobile communication systems, 5G New Radio (NR) systems, or other future new mobile communication systems, etc.

In the embodiments of the present disclosure, the network device 11 is an entity on the network side used for transmitting or receiving signals. For example, the network device 11 may be an evolved NodeB (eNB), a transmission reception point (TRP), a next-generation NodeB (gNB) in an NR system, a base station in other future mobile communication systems, or an access node in a wireless fidelity (Wi-Fi) system, etc. The embodiments of the present disclosure do not limit the specific technology and specific device form of the network device. The network device provided in the embodiments of the present disclosure may include a central unit (CU) and a distributed unit (DU), where the CU may also be referred to as a control unit. Using the CU-DU structure can separate the protocol layers of the network device, such as a base station, with functions of some protocol layers centralized in the CU and functions of the remaining or all protocol layers distributed in the DU for centralized control by the CU.

In the embodiments of the present disclosure, the terminal 12 is an entity on the user side used for receiving or transmitting signals, such as a mobile phone. The terminal can also be referred to as a terminal device, user equipment (UE), mobile station (MS), mobile terminal (MT), etc. The terminal can be a car with communication function, smart car, mobile phone, wearable device, tablet computer (Pad), computer with wireless transceiver function, virtual reality (VR) terminal, augmented reality (AR) terminal, wireless terminal in industrial control, wireless terminal in self-driving, wireless terminal in remote medical surgery, wireless terminal in smart grid, wireless terminal in transportation safety, wireless terminal in smart city, wireless terminal in smart home, etc. The embodiments of the present disclosure do not limit the specific technology and specific device form of the terminal.

It can be understood that the communication system described in the embodiments of the present disclosure is intended to more clearly illustrate the technical solutions of the embodiments of the present disclosure and does not constitute a limitation on the technical solutions provided by the embodiments of the present disclosure. Those of ordinary skill in the art would understand that with the evolution of system architecture and the emergence of new service scenarios, the technical solutions provided by the embodiments of the present disclosure are equally applicable to similar technical problems.

Typically, when the terminal reports location information obtained based on GNSS measurements to the network device, the network device may consider the location information unreliable. To avoid that time-frequency resources allocated by the network device for the terminal based on the location information conflicts with other terminals, the network device can instruct the terminal device to report the TA when the network device considers the location information unreliable. In this way, based on the TA reported by the terminal, the network device can verify the location information reported by the terminal. A method and device for determining location information provided by the present disclosure are described in detail below in conjunction with the accompanying drawings.

Please refer to FIG. 2, which is a flowchart of a method for determining location information provided in an embodiment of the present disclosure. The method is performed by a network device. As shown in FIG. 2, the method can include, but is not limited to, the following steps.

Step 201, triggering, in response to determining that location information reported by a first terminal meets a preset condition, the first terminal to perform TA reporting.

In the present disclosure, after obtaining the location information, the terminal can send the location information to the network device. However, there may be instances where the terminal reports incorrect location information, or the reported location information is tampered with. Therefore, the network device can trigger the first terminal to perform TA reporting when the network device determines that the location information reported by the first terminal meets the preset condition, in order to verify the reliability of the reported location information and ensure its accuracy.

Optionally, the preset condition can be agreed upon in a protocol or pre-configured, which is not limited in the present disclosure.

Optionally, the network device can determine that the location information reported by the first terminal meets the preset condition in response to a success rate of uplink transmissions corresponding to the first terminal being less than a first threshold.

In the present disclosure, after the network device schedules resources based on the location information reported by the first terminal, if the location information reported by the first terminal is inaccurate, the uplink transmission, when the data is transmitted by the first terminal based on the allocated resources, may be interfered with, causing the network device to fail to demodulate the transmitted data from the first terminal, i.e., uplink transmission data failure. Therefore, the network device can determine whether the location information reported by the first terminal meets the preset condition, based on the success rate of uplink transmissions corresponding to the first terminal.

When the success rate of uplink transmissions is high, the reliability of the corresponding location information can be determined to be high. When the success rate of uplink transmissions is low, the reliability of the corresponding location information can be determined to be low. The first threshold can be agreed upon in a protocol, or pre-configured in the system, which is not limited in the present disclosure.

In the present disclosure, the network device triggers the first terminal to perform TA reporting when the network device determines that the location information reported by the first terminal meets the preset condition, in order to verify the location information reported by the first terminal, thereby avoiding resource scheduling conflicts and ensuring communication reliability.

Please refer to FIG. 3, which is a flowchart of a method for determining location information provided in an embodiment of the present disclosure. The method is performed by a network device. As shown in FIG. 3, the method can include, but is not limited to, the following steps.

Step 301, in response to a success rate of uplink transmissions corresponding to a second terminal associated with the first terminal being less than a second threshold, determining that the location information reported by the first terminal meets the preset condition.

In the present disclosure, in response to a distance between location information reported by any one of terminals and the location information reported by the first terminal being less than a third threshold, and a confidence coefficient or a confidence level, or a confidence degree of the location information reported by said any one of terminals being greater than a fourth threshold, said any one of terminals is determined as the second terminal.

The third threshold and the fourth threshold can be agreed upon in a protocol, or pre-configured, which is not limited in the present disclosure.

Optionally, in response to an interval between a scheduling resource corresponding to any one of terminals and a scheduling resource corresponding to the first terminal being greater than a fifth threshold, and a confidence coefficient or a confidence level, or a confidence degree of location information reported by said any one of terminals being greater than a fourth threshold, said any one of terminals is determined as the second terminal.

The scheduling resource can be time-frequency resource, etc. The fifth threshold can be agreed upon in a protocol, or pre-configured, which is not limited in the present disclosure.

In the present disclosure, after the network device schedules resources for the second terminal and the second terminal transmits data based on allocated resources, if there is a high probability of failure when the network device demodulates the data sent by the second terminal and the location information reported by the second terminal is reliable, it may be due to the inaccuracy of the location information reported by the first terminal, causing a conflict in the resources allocated by the network device to the first terminal and the second terminal, thereby leading to the failure of the second terminal to transmit data. Therefore, the reliability of the location information reported by the first terminal can be determined based on the success rate of uplink transmissions corresponding to the second terminal. When the success rate of uplink transmissions is low, the reliability of the location information corresponding to the first terminal can be determined to be low.

Step 302, triggering the first terminal to perform TA reporting.

In the present disclosure, the network device can trigger the first terminal to perform TA reporting by sending a trigger instruction.

Optionally, the network device can trigger the first terminal to perform TA reporting through a Radio Resource Control (RRC) message.

In the present disclosure, the network device can use any bit in the RRC message to indicate the trigger for the first terminal to perform TA reporting. For example, said “any bit” is set to 0 by default. When it is necessary to trigger the first terminal to perform TA reporting, said “any bit” can be set to 1. Thus, after receiving the RRC message, the terminal can determine whether to perform TA reporting based on the value of this bit.

Optionally, the network device can also trigger the first terminal to perform TA reporting through a Media Access Control (MAC) Control Element (CE).

In the present disclosure, the network device can use any bit in the MAC CE to indicate the trigger for the first terminal to perform TA reporting. For example, said “any bit” is set to 0 by default. When it is necessary to trigger the first terminal to perform TA reporting, said “any bit” can be set to 1. Thus, after receiving the MAC CE message, the terminal can determine whether to perform TA reporting based on the value of this bit.

Optionally, the network device can also trigger the first terminal to perform TA reporting through physical layer signaling.

In the present disclosure, the network device can use any bit in the physical layer signaling to indicate the trigger for the first terminal to perform TA reporting. For example, said “any bit” is set to 0 by default. When it is necessary to trigger the first terminal to perform TA reporting, said “any bit” can be set to 1. Thus, after receiving the physical layer signaling, the terminal can determine whether to perform TA reporting based on the value of this bit.

In the present disclosure, the network device can determine that the location information reported by the first terminal meets the preset condition when the success rate of uplink transmissions corresponding to a second terminal associated with the first terminal is less than a second threshold. Then, the network device can trigger the first terminal to perform TA reporting, in order to verify the location information reported by the first terminal, thereby avoiding resource scheduling conflicts and ensuring communication reliability.

Please refer to FIG. 4, which is a flowchart of a method for determining location information provided in an embodiment of the present disclosure. The method is performed by a network device. As shown in FIG. 4, the method can include, but is not limited to, the following steps.

Step 401, sending a first indication message to the first terminal, where the first indication message is configured to indicate configuration information for TA measurement and/or configuration information for TA reporting to the first terminal.

The configuration information for TA measurement can include: an identifier of the configuration information for TA measurement, a measurement target, or time information for performing the TA measurement, etc. The configuration information for TA reporting can include: an identifier of the configuration information for TA reporting, or time information for TA reporting, etc. The present disclosure is not limited thereto.

In the present disclosure, the configuration information for TA measurement can be used to instruct the terminal to perform TA measurement to determine the delay time from the terminal to the network device. The configuration information for TA reporting can be used to instruct the terminal on how to perform TA reporting. The identifier of the configuration information for TA measurement can be any information that can be used to uniquely determine the measurement configuration, such as a number of the configuration information for TA measurement. The measurement target can be the measurement signal assigned to the terminal by the network device. The identifier of the configuration information for TA reporting can be any information that can be used to uniquely determine the reporting configuration, such as a number of the reporting configuration.

In the present disclosure, the network device can directly send the configuration information for TA measurement or the configuration information for TA reporting to the terminal. Alternatively, when the network device has already sent a plurality of pieces of configuration information for TA measurement to the terminal, the network device can send an identifier of one of pieces of configuration information for TA measurement to the terminal. After receiving the plurality of pieces of configuration information for TA measurement sent by the network device, the terminal can determine the relevant configuration for TA measurement based on the identifier and then perform TA measurement according to the configuration. When the network device has already sent a plurality of pieces of configuration information for TA reporting to the terminal, the network device can send an identifier of one of pieces of configuration information for TA reporting to the terminal. The terminal can then determine the relevant configuration for TA reporting based on the identifier and perform TA reporting according to the time information for TA reporting.

Optionally, the network device can configure the first indication message in system information, or Radio Resource Control (RRC) signaling, or Media Access Control Control Element (MAC CE), or physical layer signaling. The present disclosure is not limited thereto.

Step 402, triggering the first terminal to perform TA reporting in response to determining that the location information reported by the first terminal meets the preset condition.

The specific implementation process of Step 402 can refer to the detailed descriptions in any embodiment of the present disclosure and will not be repeated here.

It should be noted that the execution order of Step 402 and Step 401 is not limited in the present disclosure, i.e., Step 402 and Step 401 can be executed simultaneously, or Step 402 can be executed before Step 401. The present disclosure is not limited thereto.

In the present disclosure, after the network device sends the first indication message to the first terminal to indicate the configuration information for TA measurement and/or the configuration information TA reporting, the network device can trigger the first terminal to perform TA reporting when the network device determines that the location information reported by the first terminal meets the preset condition, in order to verify the location information reported by the first terminal, thereby avoiding resource scheduling conflicts and ensuring communication reliability.

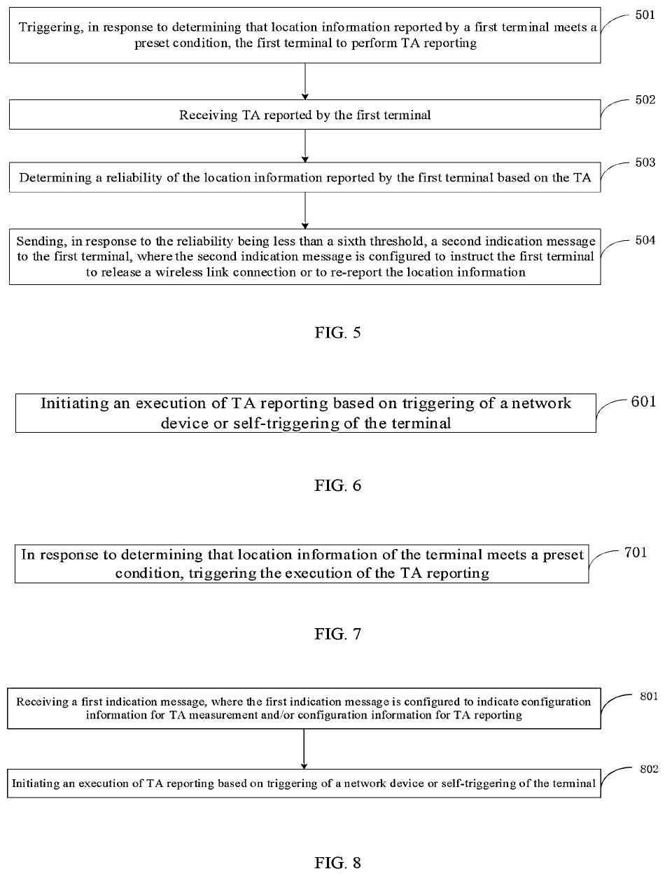

Please refer to FIG. 5, which is a flowchart of a method for determining location information provided in an embodiment of the present disclosure. The method is performed by a network device. As shown in FIG. 5, the method can include, but is not limited to, the following steps.

Step 501, triggering, in response to determining that location information reported by a first terminal meets a preset condition, the first terminal to perform TA reporting.

The specific implementation process of Step 501 can refer to the detailed descriptions in any embodiment of the present disclosure and will not be repeated here.

Step 502, receiving TA reported by the first terminal.

In the present disclosure, after receiving the trigger instruction for TA reporting sent by the network device, the first terminal can report the TA information to the network device. Alternatively, the first terminal can autonomously trigger the initiation of the execution of TA reporting.

Step 503, determining a reliability of the location information reported by the first terminal based on the TA.

Step 504, sending, in response to the reliability being less than a sixth threshold, a second indication message to the first terminal, where the second indication message is configured to instruct the first terminal to release a wireless link connection or to re-report the location information.

The sixth threshold can be agreed upon in a protocol, or pre-configured, which is not limited in the present disclosure.

In the present disclosure, any bit in the sent instruction can be used to indicate the second indication message. For example, if the second indication message is used to instruct the first terminal to release the wireless link connection, this bit can be set to 0. If the second indication message is used to instruct the first terminal to re-report the location information, this bit can be set to 1.

In the present disclosure, after the network device triggers the first terminal to perform TA reporting when the network device determines that the location information reported by the first terminal meets the preset condition, the network device can receive the TA reported by the first terminal. Then, the network device can determine the reliability of the location information reported by the first terminal based on the TA. If the reliability is less than the sixth threshold, the network device can send a second indication message to instruct the first terminal to release the wireless link connection or re-report the location information. This improves the reliability of the location information of the terminal, thereby avoiding resource scheduling conflicts and ensuring communication reliability.

Please refer to FIG. 6, which is a flowchart of a method for determining location information provided in an embodiment of the present disclosure. The method is performed by a terminal device. As shown in FIG. 6, the method can include, but is not limited to, the following steps.

Step 601, initiating an execution of TA reporting based on triggering of a network device or self-triggering of the terminal.

In the present disclosure, after obtaining the location information, the terminal can send the location information to the network device. However, there may be instances where the terminal reports incorrect location information, or the reported location information is tampered with. Therefore, the network device can trigger the first terminal to perform TA reporting when the network device determines that the location information reported by the first terminal meets the preset condition, in order to verify the reliability of the reported location information and ensure its accuracy.

Optionally, the preset condition can be agreed upon in a protocol or pre-configured, which is not limited in the present disclosure.

Optionally, the network device can determine that the location information reported by the first terminal meets the preset condition in response to a success rate of uplink transmissions corresponding to the first terminal being less than a first threshold.

In the present disclosure, after the network device schedules resources based on the location information reported by the first terminal, if the location information reported by the first terminal is inaccurate, the uplink transmission, when the data is transmitted by the first terminal based on the allocated resources, may be interfered with, causing the network device to fail to demodulate the transmitted data from the first terminal, i.e., uplink transmission data failure. Therefore, the network device can determine whether the location information reported by the first terminal meets the preset condition, based on the success rate of uplink transmissions corresponding to the first terminal.

When the success rate of uplink transmissions is high, the reliability of the corresponding location information can be determined to be high. When the success rate of uplink transmissions is low, the reliability of the corresponding location information can be determined to be low. The first threshold can be agreed upon in a protocol, or pre-configured in the system, which is not limited in the present disclosure.

Optionally, the terminal can also autonomously trigger the initiation of the execution of TA reporting. For example, when the terminal has a high decoding failure rate, it can initiate the execution of TA reporting.

In the present disclosure, the terminal can initiate the execution of TA reporting based on the triggering of the network device or the self-triggering of the terminal, which enables the location information reported by the terminal to be verified, thereby avoiding resource scheduling conflicts and ensuring the communication reliability.

Please refer to FIG. 7, which is a flowchart of a method for determining location information provided in an embodiment of the present disclosure. The method is performed by a terminal device. As shown in FIG. 7, the method can include, but is not limited to, the following steps.

Step 701, in response to determining that location information of the terminal meets a preset condition, triggering the execution of the TA reporting.

In the present disclosure, the terminal can determine that the location information of the terminal meets the preset condition in response to failing to receive Hybrid Automatic Repeat Request (HARQ) feedbacks for a preset number of uplink transmissions.

In the present disclosure, in the case of decoding failure, the terminal can save the received data and request the network device to retransmit the data. The terminal will combine the retransmitted data with the previously received data and then decode it. When the terminal does not receive the HARQ feedback information sent by the network device, it can be indicated that there is an error in the uplink transmission, which might be caused by unreliable location information of the terminal. Therefore, the terminal can count the number of times it has not received feedback for uplink transmission. When this count reaches a preset number, it can be determined that the location information of the terminal meets the preset condition.

Optionally, the terminal can also determine that its location information meets the preset condition in response to a proportion of Negative Acknowledgment (NACK) messages in received HARQ feedbacks being greater than a first limit value.

A NACK message is used to indicate a message that the device cannot understand or a request operation that cannot be executed. The terminal can count the proportion of NACKs in the received HARQ feedbacks. When this proportion is greater than the first limit value, it can be determined that the location information of the terminal meets the preset condition. The first limit value can be agreed upon in a protocol, or pre-configured, which is not limited in the present disclosure.

Optionally, the terminal can also determine that its location information meets the preset condition in response to failing to receive HARQ feedbacks for uplink transmissions within a preset period.

In the present disclosure, the terminal can determine the preset period based on the delay of the uplink transmission. For example, the delay of the uplink transmission can be set as the preset period, or the preset period can be set to be longer than the delay of the uplink transmission. The terminal can start timing when sending HARQ information. If the terminal has not received HARQ feedback information when the timing reaches the preset period, it can be determined that the location information of the terminal meets the preset condition.

Optionally, the terminal can also determine that its location information meets the preset condition in response to a proportion of NACK messages in received HARQ feedbacks within a preset period being greater than a second limit value.

The second limit value can be agreed upon in a protocol, or pre-configured, which is not limited in the present disclosure.

In the present disclosure, when the terminal determines that its location information meets the preset condition, the terminal triggers the execution of TA reporting, which enables the location information reported by the terminal to be verified, thereby avoiding resource scheduling conflicts and ensuring the communication reliability.

Please refer to FIG. 8, which is a flowchart of a method for determining location information provided in an embodiment of the present disclosure. The method is performed by a terminal device. As shown in FIG. 8, the method can include, but is not limited to, the following steps.

Step 801, receiving a first indication message, where the first indication message is configured to indicate configuration information for TA measurement and/or configuration information for TA reporting.

The configuration information for TA measurement can include: an identifier of the configuration information for TA measurement, a measurement target, or time information for performing the TA measurement, etc. The configuration information for TA reporting can include: an identifier of the configuration information for TA reporting, or time information for TA reporting, etc. The present disclosure is not limited thereto.

In the present disclosure, the configuration information for TA measurement can be used to instruct the terminal to perform TA measurement to determine the delay time from the terminal to the network device. The configuration information for TA reporting can be used to instruct the terminal on how to perform TA reporting. The identifier of the configuration information for TA measurement can be any information that can be used to uniquely determine the measurement configuration, such as a number of the configuration information for TA measurement. The measurement target can be the measurement signal assigned to the terminal by the network device. The identifier of the configuration information for TA reporting can be any information that can be used to uniquely determine the reporting configuration, such as a number of the reporting configuration.

In the present disclosure, the network device can directly send the configuration information for TA measurement or the configuration information for TA reporting to the terminal. Alternatively, when the network device has already sent a plurality of pieces of configuration information for TA measurement to the terminal, the network device can send an identifier of one of pieces of configuration information for TA measurement to the terminal. After receiving the plurality of pieces of configuration information for TA measurement sent by the network device, the terminal can determine the relevant configuration for TA measurement based on the identifier and then perform TA measurement according to the configuration. When the network device has already sent a plurality of pieces of configuration information for TA reporting to the terminal, the network device can send an identifier of one of pieces of configuration information for TA reporting to the terminal. The terminal can then determine the relevant configuration for TA reporting based on the identifier and perform TA reporting according to the time information for TA reporting.

Optionally, the network device can configure the first indication message in system information, or Radio Resource Control (RRC) signaling, or Media Access Control Control Element (MAC CE), or physical layer signaling. The present disclosure is not limited thereto.

Optionally, the terminal device can also determine the configuration information for TA reporting based on a preset rule. The rule can be configured by a network or agreed upon in a protocol. The present disclosure is not limited thereto.

Step 802, initiating an execution of TA reporting based on triggering of a network device or self-triggering of the terminal.

The specific implementation process of Step 802 can refer to the detailed descriptions in any embodiment of the present disclosure and will not be repeated here.

In the present disclosure, the terminal can receive a first indication message used to indicate the configuration information for TA measurement and/or TA reporting. Then, based on the triggering of the network device or the self-triggering of the terminal, the terminal can initiate the execution of TA reporting, which enables the location information reported by the first terminal to be verified, thereby avoiding resource scheduling conflicts and ensuring the reliability of communication.

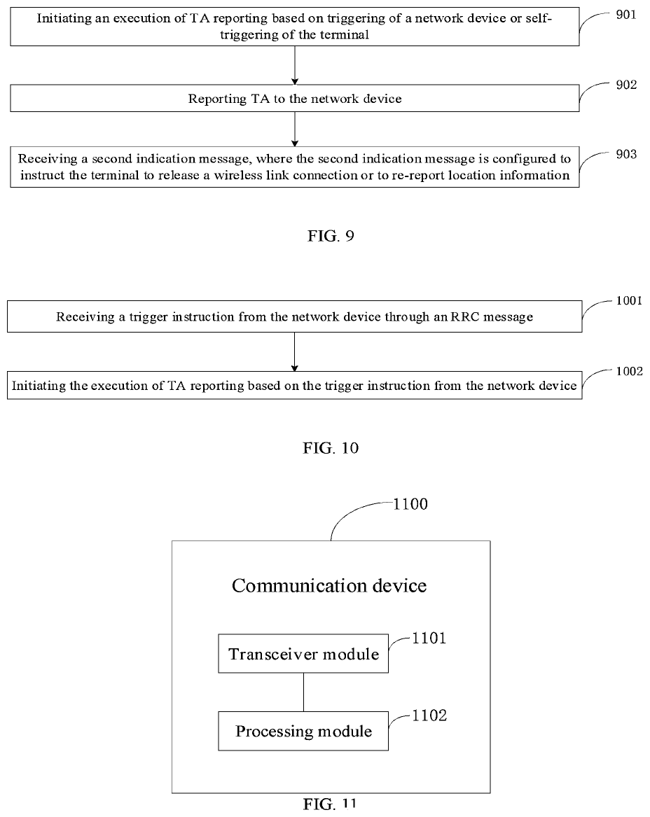

Please refer to FIG. 9, which is a flowchart of a method for determining location information provided in an embodiment of the present disclosure. The method is performed by a terminal device. As shown in FIG. 9, the method can include, but is not limited to, the following steps.

Step 901, initiating an execution of TA reporting based on triggering of a network device or self-triggering of the terminal.

The specific implementation process of Step 901 can refer to the detailed descriptions in any embodiment of the present disclosure and will not be repeated here.

Step 902, reporting TA to the network device.

Step 903, receiving a second indication message, where the second indication message is configured to instruct the terminal to release a wireless link connection or to re-report location information.

In the present disclosure, any bit in the sent instruction can be used to indicate the second indication message. For example, if the second indication message is used to instruct the first terminal to release the wireless link connection, this bit can be set to 0. If the second indication message is used to instruct the first terminal to re-report the location information, this bit can be set to 1.

In the present disclosure, after receiving the second indication message, the terminal can perform the corresponding operation according to the instructions in the second indication message.

In the present disclosure, after the terminal initiates the execution of TA reporting based on the triggering of the network device or the self-triggering of the terminal, it reports the TA to the network device. Subsequently, the terminal can receive a second indication message used to instruct the terminal to release the wireless link connection or to re-report the location information. This can improve the reliability of the location information of the terminal, thereby avoiding resource scheduling conflicts and ensuring communication reliability.

Please refer to FIG. 10, which is a flowchart of a method for determining location information provided in an embodiment of the present disclosure. The method is performed by a terminal. As shown in FIG. 10, the method can include, but is not limited to, the following steps.

Step 1001, receiving a trigger instruction from the network device through an RRC message.

In the present disclosure, any bit in the RRC message can be used to indicate the trigger for the first terminal to perform TA reporting. For example, said “any bit” is set to 0 by default. When it is necessary to trigger the first terminal to perform TA reporting, said “any bit” can be set to 1. Thus, after receiving the RRC message, the terminal device can determine whether to perform TA reporting based on the value of this bit.

Optionally, the terminal can also receive the trigger instruction from the network device through a MAC CE.

In the present disclosure, the network device can use any bit in the MAC CE to indicate the trigger for the first terminal to perform TA reporting. For example, said “any bit” is set to 0 by default. When it is necessary to trigger the first terminal to perform TA reporting, said “any bit” can be set to 1. Thus, after receiving the MAC CE message, the terminal can determine whether to perform TA reporting based on the value of this bit.

Optionally, the terminal can also receive the trigger instruction from the network device through physical layer signaling.

In the present disclosure, the network device can use any bit in the physical layer signaling to indicate the trigger for the first terminal to perform TA reporting. For example, said “any bit” is set to 0 by default. When it is necessary to trigger the first terminal to perform TA reporting, said “any bit” can be set to 1. Thus, after receiving the physical layer signaling, the terminal can determine whether to perform TA reporting based on the value of this bit.

Step 1002, initiating the execution of TA reporting based on the trigger instruction from the network device.

The specific implementation process of Step 1002 can refer to the detailed descriptions in any embodiment of the present disclosure and will not be repeated here.

In the present disclosure, after receiving the trigger instruction from the network device through an RRC message, the terminal can initiate the execution of TA reporting based on the trigger instruction from the network device, which enables the location information reported by the first terminal to be verified, thereby avoiding resource scheduling conflicts and ensuring the reliability of communication.

Please refer to FIG. 11, which is a structural diagram of a communication device 1100 provided in an embodiment of the present disclosure. The communication device 1100 shown in FIG. 11 can include a transceiver module 1101 and a processing module 1102. The transceiver module 1101 can include a sending module and/or a receiving module. The sending module is used to implement the sending function, and the receiving module is used to implement the receiving function. The transceiver module 1101 can implement the sending function and/or the receiving function.

It should be understood that the communication device 1100 can be a network device, a device in a network device, or a device that can be matched with a network device.

The communication device 1100 is on a network device side.

The transceiver module 1101 is configured to trigger, in response to determining that location information reported by a first terminal meets a preset condition, the first terminal to perform TA reporting.

Optionally, the communication device also includes:
a processing module 1102 configured to determine that the location information reported by the first terminal meets the preset condition in response to a success rate of uplink transmissions corresponding to the first terminal being less than a first threshold; or
to determine that the location information reported by the first terminal meets the preset condition in response to a success rate of uplink transmissions corresponding to a second terminal associated with the first terminal being less than a second threshold.

Optionally, the processing module 1102 is further configured to:
in response to a distance between location information reported by any one of terminals and the location information reported by the first terminal being less than a third threshold and a confidence coefficient of the location information reported by said any one of terminals being greater than a fourth threshold, determine said any one of terminals as the second terminal; or
in response to an interval between a scheduling resource corresponding to any one of terminals and a scheduling resource corresponding to the first terminal being greater than a fifth threshold and a confidence coefficient of location information reported by said any one of terminals being greater than a fourth threshold, determine said any one of terminals as the second terminal.

Optionally, the transceiver module 1101 is further configured to:
send a first indication message to the first terminal, wherein the first indication message is configured to indicate configuration information for TA measurement and/or configuration information for TA reporting to the first terminal.

Optionally, the configuration information for TA measurement comprises any one of:
an identifier of the configuration information for TA measurement;
a measurement target; or
time information for performing the TA measurement.

Optionally, the configuration information for TA reporting comprises any one of: an identifier of the configuration information for TA reporting; or time information for TA reporting.

Optionally, the transceiver module 1101 is further configured to:
receive TA reported by the first terminal; and
the processing module 1102 is configured to determine a reliability of the location information reported by the first terminal based on the TA; and;
to send, in response to the reliability being less than a sixth threshold, a second indication message to the first terminal, wherein the second indication message is configured to instruct the first terminal to release a wireless link connection or to re-report the location information.

Optionally, the transceiver module 1101 is further configured to:
trigger the first terminal to perform TA reporting through a RRC message; or
trigger the first terminal to perform TA reporting through a MAC CE; or
trigger the first terminal to perform TA reporting through physical layer signaling.

It should be understood that the communication device 1100 can be a terminal, a device in a terminal, or a device that can be matched with a terminal.

The communication device 1100 on a terminal device side.

The transceiver module 1101 is configured to initiate an execution of TA reporting based on triggering of a network device or self-triggering of the communication device.

Optionally, the transceiver module 1101 is further configured to:
in response to determining that location information of a terminal meets a preset condition, trigger the execution of the TA reporting.

Optionally, the communication device further includes:
a processing module 1102 configured to determine that the location information of the terminal meets the preset condition in response to failing to receive HARQ feedbacks for a preset number of uplink transmissions; or
to determine that the location information of the terminal meets the preset condition in response to a proportion of NACK messages in received HARQ feedbacks being greater than a first limit value; or
to determine that the location information of the terminal meets the preset condition in response to failing to receive HARQ feedbacks for uplink transmissions within a preset period; or
to determine that the location information of the terminal meets the preset condition in response to a proportion of NACK messages in received HARQ feedbacks within a preset period being greater than a second limit value.

Optionally, the transceiver module 1101 is further configured to:
receive a first indication message, wherein the first indication message is configured to indicate configuration information for TA measurement and/or configuration information for TA reporting.

Optionally, the configuration information for TA measurement includes any one of:
an identifier of the configuration information for TA measurement;
a measurement target; or
time information for executing the TA measurement.

Optionally, the processing module 1102 is further configured to:
determine configuration information for TA reporting based on a preset rule.

Optionally, the configuration information for TA reporting comprises any one of: an identifier of the configuration information for TA reporting; or time information for TA reporting.

Optionally, the transceiver module 1101 is further configured to:
report TA to the network device.

Optionally, the transceiver module 1101 is further configured to:
receive a second indication message, wherein the second indication message is configured to instruct the terminal to release a wireless link connection or to re-report location information.

Optionally, the transceiver module 1101 is further configured to:
receive a trigger instruction from the network device through a RRC message; or
receive a trigger instruction from the network device through a MAC CE; or
receive a trigger instruction from the network device through physical layer signaling.

In the present disclosure, when determining that the location information reported by the first terminal meets the preset condition, the network device triggers the first terminal to perform TA reporting in order to verify the location information reported by the first terminal, thereby avoiding resource scheduling conflicts and ensuring the reliability of communication.

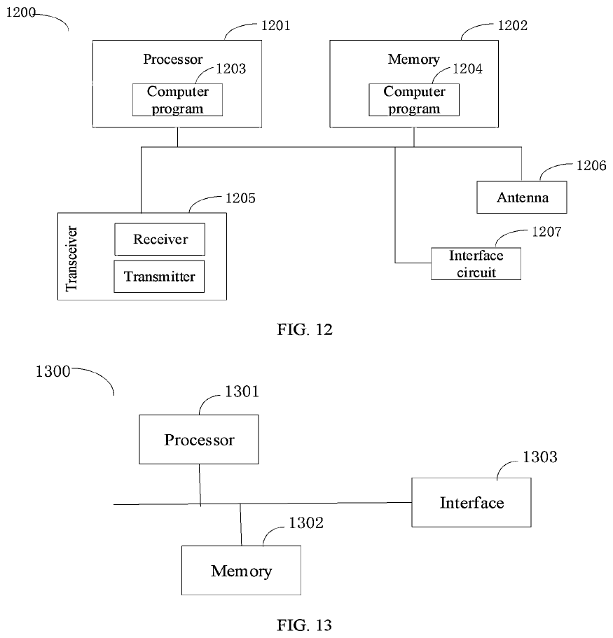

Please refer to FIG. 12, which is a structural diagram of another communication device 1200 provided in an embodiment of the present disclosure. The communication device 1200 can be a network device, a terminal, or a chip, chip system, or processor that supports the network device to implement the above methods, or a chip, chip system, or processor that supports the terminal to implement the above methods. The device can be used to implement the methods described in the above method embodiments, specifically referring to the descriptions in the above method embodiments.

The communication device 1200 can include one or more processors 1201. The processor 1201 can be a general-purpose processor or a special-purpose processor, such as a baseband processor or a central processor. The baseband processor can be used to process communication protocols and communication data, and the central processor can be used to control the communication device (such as a base station, baseband chip, terminal, terminal chip, DU, or CU), execute computer programs, and process data from computer programs.

Optionally, the communication device 1200 can also include one or more memory 1202, which can store a computer program 1204 that when executed by the processor 1201 causes the communication device 1200 to implement the methods described in the above method embodiments. Optionally, the memory 1202 can also store data. The communication device 1200 and the memory 1202 can be set separately or integrated together.

Optionally, the communication device 1200 can also include a transceiver 1205 and an antenna 1206. The transceiver 1205 can be referred to as a transceiver unit, transceiver machine, or transceiver circuit, etc., used to implement the transceiver function. The transceiver 1205 can include a receiver and a transmitter. The receiver can be referred to as a receiver machine or receiver circuit, etc., used to implement the receiving function. The transmitter can be referred to as a transmitter machine or transmitter circuit, etc., used to implement the sending function.

Optionally, the communication device 1200 can also include one or more interface circuits 1207. The interface circuit 1207 is used to receive code instructions and transmit them to the processor 1201. The processor 1201 runs the code instructions to enable the communication device 1200 to implement the methods described in the above method embodiments.

When the communication device 1200 is a network device, the processor 1201 is used to execute Step 301 in FIG. 3, Step 503 in FIG. 5, etc.

When the communication device 1200 is a terminal, the transceiver 1205 is used to execute Step 601 in FIG. 6, Step 701 in FIG. 7, Steps 801 and 802 in FIG. 8, Steps 901, 902, and 903 in FIG. 9; and Steps 1001 and 1002 in FIG. 10, etc.

In one embodiment, the processor 1201 can include a transceiver for implementing the receiving and sending functions. For example, the transceiver can be a transceiver circuit, or an interface, or an interface circuit. The transceiver circuit, interface, or interface circuit for receiving and sending functions can be separate or integrated. The transceiver circuit, interface, or interface circuit can be used for reading and writing codes/data, or for transmitting or delivering signals.

In one embodiment, the processor 1201 can store a computer program 1203, which, when executed on the processor 1201, enables the communication device 1200 to perform the methods described in the above method embodiments. The computer program 1203 may be embedded in the processor 1201, in which case the processor 1201 may be implemented by hardware.

In one embodiment, the communication device 1200 can include circuitry that implements the sending, receiving, or communication functions described in the preceding method embodiments. The processors and transceivers described in this disclosure can be implemented in integrated circuits (ICs), analog ICs, radio frequency ICs (RFICs), mixed-signal ICs, application specific ICs (ASICs), printed circuit boards (PCBs), electronic devices, and the like. These processors and transceivers can also be manufactured using various IC process technologies, such as complementary metal oxide semiconductor (CMOS), n-type metal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs), and others.

The communication devices described in the above embodiments can be network devices or access network devices (such as terminal devices in the preceding method embodiments). However, the scope of the communication devices described in this disclosure is not limited to this, and the structure of the communication devices is not limited by FIG. 12. The communication device can be an independent device or a part of a larger device. For example, the communication device can be:
(1) an independent IC, chip, or chip system or subsystem;
(2) a collection of one or more ICs, optionally including memory components for storing data and computer programs;
(3) an ASIC, such as a modem;
(4) a module that can be embedded in other devices;
(5) a receiver, terminal, smart terminal, cellular phone, wireless device, handheld device, mobile unit, vehicle-mounted device, network device, cloud device, AI device, etc.;
(6) other similar devices.

For the case where the communication device is a chip or chip system, refer to the schematic diagram of the chip structure shown in FIG. 13. The chip shown in FIG. 13 includes a processor 1301 and an interface 1303. There may be one or more processors 1301 and a plurality of interfaces 1303.

For the chip used to implement the functions of the network device in the embodiments of the present disclosure:
the interface 1303 is used to execute Step 201 in FIG. 2, Step 302 in FIG. 3, or Steps 401 and 402 in FIG. 4, etc.

For the chip used to implement the functions of the terminal in the embodiments of the present disclosure:
the interface 1303 is used to execute Step 601 in FIG. 6, or Step 701 in FIG. 7, etc.

Optionally, the chip also includes memory 1303, which is used to store necessary computer programs and data.

A person skilled in the art can also understand that the various illustrative logical blocks and steps listed in the embodiments of this disclosure can be implemented by electronic hardware, computer software, or a combination thereof. Whether these functions are implemented through hardware or software depends on the specific application and the overall design requirements of the system. A person skilled in the art can use various methods to implement the described functions for each specific application, but such implementations should not be construed as beyond the protection scope of the embodiments of this disclosure.

This disclosure also provides a readable storage medium on which instructions are stored. When the instructions are executed by a computer, the functions of any of the method embodiments described above are implemented.

This disclosure also provides a computer program product. When the computer program product is executed by a computer, the functions of any of the method embodiments described above are implemented.

In the above embodiments, the implementation can be entirely or partly through software, hardware, firmware, or any combination thereof. When implemented using software, it can be entirely or partly in the form of a computer program product. The computer program product includes one or more computer programs. When loaded and executed on a computer, the computer program product generates, entirely or partly, the processes or functions described in the embodiments of this disclosure. The computer can be a general-purpose computer, a special-purpose computer, a computer network, or other programmable devices. The computer program can be stored in a computer-readable storage medium or transmitted from one computer-readable storage medium to another, for example, from a website, computer, server, or data center to another website, computer, server, or data center via wired (e.g., coaxial cable, optical fiber, Digital Subscriber Line (DSL)) or wireless (e.g., infrared, wireless, microwave) means. The computer-readable storage medium can be any available medium that the computer can access or a data storage device such as a server or data center that integrates one or more available media. The available media can include magnetic media (e.g., floppy disks, hard disks, magnetic tapes), optical media (e.g., Digital Video Discs (DVDs)), or semiconductor media (e.g., Solid State Disks (SSDs)), etc.

It can be understood that “a plurality of” or “multiple” in this disclosure refers to two or more, and other quantifiers are similar. “And/or” describes the associative relationship of associated objects, indicating that three relationships can exist. For example, A and/or B can indicate: A alone, both A and B, or B alone. The character “/” generally indicates an “or” relationship between the associated objects. The singular forms of “a/an,” “the,” and “said” are also intended to include plural forms unless the context clearly indicates otherwise.

Furthermore, it can be understood that although the operations in the embodiments of this disclosure are described in a specific order in the accompanying drawings, this should not be understood as requiring the operations to be performed in the specific order shown or in a serial order, or requiring all operations to be performed to achieve the desired result. In specific environments, multitasking and parallel processing may be advantageous.

A person of ordinary skill in the art can understand that the first, second, and various other numerical numbers involved in this disclosure are only described for the convenience of differentiation, and are not used to limit the scope of the embodiments of the present disclosure, and also indicate the order of precedence.

“At least one” in this disclosure can also be described as one or more, which can be two, three, four, or more, and this disclosure does not limit this. In the embodiments of this disclosure, for a technical feature, the technical features are distinguished by “first,” “second,” “third,” “A,” “B,” “C,” and “D,” etc. There is no sequential order or size order among the technical features described by “first,” “second,” “third,” “A,” “B,” “C,” and “D.”

The correspondence relationships shown in the tables in this disclosure can be configured or predefined. The values of the information in the tables are merely examples and can be configured to other values, and this disclosure does not limit this. When configuring the correspondence relationships between information and parameters, it is not necessarily required to configure all the correspondence relationships shown in the tables. For example, some correspondence relationships shown in certain rows in the tables can also not be configured. Also, appropriate modifications such as splitting or merging can be made based on the above tables. The parameter names shown in the titles of the tables can also use other names understandable by the communication device, and the values or representations of the parameters can also use other values or representations understandable by the communication device. When implementing the above tables, other data structures can also be used, such as arrays, queues, containers, stacks, linear tables, pointers, linked lists, trees, graphs, structures, classes, heaps, hash tables, or hash maps.

“Predefined” in this disclosure can be understood as defined, pre-defined, stored, pre-stored, pre-negotiated, pre-configured, solidified, or pre-burned.

A person of ordinary skill in the art can realize that the units and algorithm steps described in the examples disclosed herein can be implemented in electronic hardware or a combination of computer software and electronic hardware. Whether these functions are executed in hardware or software depends on the specific application and design constraints of the technical solution. The skilled person may use different methods for each particular application to implement the described functions, but such implementations should not be considered beyond the scope of the present disclosure.

A person skilled in the art can clearly understand that for the convenience and brevity of description, the specific working processes of the systems, devices, and units described above can refer to the corresponding processes in the method embodiments described above, and they will not be repeated here.

A person skilled in the art, after considering the specification and practice of the disclosed invention herein, will easily conceive other embodiments of this disclosure. This application is intended to cover any variations, uses, or adaptations of the present disclosure that follow the general principles of the present disclosure and include common knowledge or customary means in the art not disclosed herein. The specification and embodiments are to be regarded as exemplary only, and the true scope and spirit of the present disclosure is indicated by the following claims.

The above descriptions are merely specific embodiments of this disclosure, but the protection scope of this disclosure is not limited thereto. Any person skilled in the art can easily conceive changes or substitutions within the technical scope disclosed by this disclosure, and they should be covered within the protection scope of this disclosure. Therefore, the protection scope of this disclosure should be subject to the scope of the claims.

1. A method for determining location information, the method being performed by a network device and comprising:
triggering, in response to determining that location information reported by a first terminal meets a preset condition, the first terminal to perform Timing Advance (TA) reporting.

2. The method of claim 1, wherein determining that the location information reported by the first terminal meets the preset condition, comprises:
in response to a success rate of uplink transmissions corresponding to the first terminal being less than a first threshold, determining that the location information reported by the first terminal meets the preset condition; or
in response to a success rate of uplink transmissions corresponding to a second terminal associated with the first terminal being less than a second threshold, determining that the location information reported by the first terminal meets the preset condition.

3. The method of claim 2, further comprising:
in response to a distance between location information reported by one of terminals and the location information reported by the first terminal being less than a third threshold and a confidence coefficient of the location information reported by the one of the terminals being greater than a fourth threshold, determining the one of the terminals as the second terminal; or
in response to an interval between a scheduling resource corresponding to the one of terminals and a scheduling resource corresponding to the first terminal being greater than a fifth threshold and the confidence coefficient of the location information reported by the one of the terminals being greater than the fourth threshold, determining the one of the terminals as the second terminal.

4. The method of claim 1, further comprising:
sending a first indication message to the first terminal, wherein the first indication message is configured to indicate configuration information for TA measurement and/or configuration information for the TA reporting to the first terminal.

5. The method of claim 4, wherein the configuration information for the TA measurement comprises at least one of:
an identifier of the configuration information for the TA measurement;
a measurement target; or
time information for performing the TA measurement.

6. The method of claim 4, wherein the configuration information for the TA reporting comprises at least one of:
an identifier of the configuration information for the TA reporting; or
time information for the TA reporting.

7. The method of claim 1, further comprising:
receiving TA reported by the first terminal;
determining a reliability of the location information reported by the first terminal based on the TA; and
sending, in response to the reliability being less than a sixth threshold, a second indication message to the first terminal, wherein the second indication message is configured to instruct the first terminal to release a wireless link connection or to re-report the location information.

8. The method of claim 1, wherein triggering the first terminal to perform the TA reporting comprises:
triggering the first terminal to perform the TA reporting through a Radio Resource Control (RRC) message; or
triggering the first terminal to perform the TA reporting through a Medium Access Control (MAC) Control Element (CE); or
triggering the first terminal to perform the TA reporting through physical layer signaling.

9. A method for determining location information, performed by a terminal, the method comprising:
initiating an execution of Timing Advance (TA) reporting based on a triggering of a network device or a self-triggering of the terminal.

10. The method of claim 9, further comprising:
in response to determining that location information of the terminal meets a preset condition, triggering the execution of the TA reporting.

11. The method of claim 10, wherein determining that the location information of the terminal meets the preset condition, comprises:
in response to failing to receive Hybrid Automatic Repeat Request (HARQ) feedbacks for a preset number of uplink transmissions, determining that the location information of the terminal meets the preset condition; or
in response to a proportion of Negative Acknowledgment (NACK) messages in received HARQ feedbacks being greater than a first limit value, determining that the location information of the terminal meets the preset condition; or
in response to failing to receive HARQ feedbacks for uplink transmissions within a preset period, determining that the location information of the terminal meets the preset condition; or
in response to a proportion of NACK messages in received HARQ feedbacks within a preset period being greater than a second limit value, determining that the location information of the terminal meets the preset condition.

12. The method of claim 9, further comprising:
receiving a first indication message, wherein the first indication message is configured to indicate configuration information for TA measurement and/or configuration information for the TA reporting.

13. The method of claim 12, wherein the configuration information for the TA measurement comprises at least one of:
an identifier of the configuration information for the TA measurement;
a measurement target; or
time information for executing the TA measurement.

14. The method of claim 9, further comprising:
determining configuration information for the TA reporting based on a preset rule.

15. The method of claim 12, wherein the configuration information for the TA reporting comprises at least one of:
an identifier of the configuration information for the TA reporting; or
time information for the TA reporting.

16. The method of claim 9, further comprising:
reporting TA to the network device.

17. The method of claim 16, further comprising:
receiving a second indication message, wherein the second indication message is configured to instruct the terminal to release a wireless link connection or to re-report the location information.

18. The method of claim 9, further comprising:
receiving a trigger instruction from the network device through a Radio Resource Control (RRC) message; or
receiving a trigger instruction from the network device through a Medium Access Control (MAC) Control Element (CE); or
receiving a trigger instruction from the network device through physical layer signaling.

19-36. (canceled)

37. A communication device, comprising:
a processor; and
a memory, a computer program being stored in the memory,
wherein the processor executes the computer program stored in the memory to cause the communication device to perform the method of claim 1.

38. A communication device, comprising:
a processor; and
a memory, a computer program being stored in the memory,
wherein the processor executes the computer program stored in the memory to cause the communication device to perform the method of claim 9.

39-40. (canceled)
